(19) United States
(12) Patent Application Publication
(10) Pub. No.: US 2009/0303411 A1
(43) Pub. Date: Dec. 10, 2009

(54) MULTILAYERED SHEET FOR LIGHT REFLECTION, REFLECTOR, LIGHTING UNIT AND LIQUID CRYSTAL DISPLAY DEVICE USING THE SAME

(75) Inventors: Hiroshi Kawato, Chiba (JP); Masami Kogure, Chiba (JP); Toshio Isozaki, Chiba (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Idemitsu Kosan Co., Ltd., Tokyo (JP)

(21) Appl. No.: 12/305,978

(22) PCT Filed: May 24, 2007
(86) PCT No.: PCT/JP2007/060622

§ 371 Date: Dec. 22, 2008

(30) Foreign Application Priority Data
Jun. 21, 2006 (JP) 2006-171758

(51) Int. Cl. G02F 1/1335; C08K 3/34; C08K 3/22; B32B 33/00; B32B 27/00; B29D 11/00; F21V 7/00

(52) U.S. Cl. 349/61; 524/449; 524/451; 524/413; 428/411.1; 428/220; 264/1.9; 362/341; 362/296.01

(57) ABSTRACT

The present invention relates to a multilayered sheet for light reflection for forming a thin and lightweight reflector, a reflector using it, a lighting unit equipped with the reflector and a liquid crystal display device equipped with the lighting unit, with reduced numbers of components in the lighting unit and in the assembly steps that are attained by preparing a reflector comprising a light reflecting plate, a boss portion for attaching a circuit, a reinforced rib portion and a light diffuser panel supporting frame, and, optionally comprising a lamp holder, a lamp supporter and a light diffuser panel supporting column integrated in a single piece, a lighting unit equipped with the reflector and a liquid crystal display device using the lighting unit, wherein the multilayered sheet for light reflection includes a multilayered sheet for light reflection comprising a light reflecting resin layer (A) and a resin substrate layer (B) which contains an inorganic filler in an amount of 30% by mass or more and has the flexural modulus of 5 GPa or more, and a multilayered sheet for light reflection further provided with a flexible resin layer (C) on the side of the resin substrate layer.

### TECHNICAL FIELD

The present invention relates to a multilayered sheet for light reflection used for production of a reflector which constitutes a lighting unit for a liquid crystal display device, a reflector using it, a lighting unit and a liquid crystal display device.

### BACKGROUND ART

Generally, a liquid crystal display device is composed of a lighting unit and a liquid crystal panel, and the lighting unit is composed of a back chassis and a front chassis made of sheet metal, a light source support, a light source, a light diffuser panel and/or light guide plate, and a backlight composed of a drive circuit such as an inverter.

However, the conventional liquid crystal display device and the lighting unit are composed of a number of components, which results in a problem of requiring many assembly steps.

The backlight is roughly classified into 3 types, a direct-type, a light guiding-type, and a tandem-type, i.e., a hybrid of both types. Among others, development of a direct type backlight, and a tandem (hybrid) type backlight in recent years is actively pursued, since the backlight used for a liquid crystal television set with a large screen requires high brightness.

### Configuration of the Direct-Type Backlight

A conventional direct-type backlight is composed of a tabular or corrugated plate-shaped reflector formed by bonding and laminating a resin foam on an aluminum sheet metal substrate, a plurality of light sources, a light source support, a light diffuser panel, a plurality of optical films and a sheet metal enclosure (back chassis and front chassis) (for example, see Patent Documents 1 to 5).

### Configuration of the Tandem (Hybrid)-Type Backlight

A conventional tandem (hybrid)-type backlight is composed of a reflector formed by bonding and laminating a resin foam on an aluminum sheet metal substrate or a plurality of reflective sheets, a plurality of light sources, a light source support, a light diffuser panel, a plurality of light guide plates, a plurality of optical films and a sheet metal enclosure (back chassis and front chassis) (for example, see Patent Documents 6 to 8).

The liquid crystal display device is composed of a liquid crystal panel laminated on the above backlight.

The reflector constituting the backlight is composed of a resin foam bonded and laminated on an aluminum sheet metal substrate, intending to prevent the reflector from warping or deforming and to retain the structure. Generally, the reflector is subjected to sheet metal working, such as a press molding to form a corrugated plate and a folding process to form a side face.

However, the method for producing the reflector by bonding and laminating the resin foam on the aluminum sheet metal substrate hardly allows sheet metal working of a complex shape (the resin foam layer is exfoliated from the aluminum substrate, resulting in a positional shift), so that a usually available aluminum material 52S may not be used, but instead, it is required to use an expensive aluminum material in order to impart sheet metal working characteristics. As a result, it was necessary to prepare separately the light source support provided with combined capacities of a reinforced structure for preventing skew of the resultant reflector, support of light source, reflection portion, and insulation function against heat generation at a light source electrode terminal, by injection molding using a polycarbonate resin/titanium oxide-based resin composition or the like, to dispose the light source to the reflector, and to attach and fix the light source support. Further, weight increase is also unavoidable in the case of the aluminum sheet metal due to the wall thickness of the chassis: 1 mm for a 22 inch class screen size; 1.5 mm for a 30 inch class screen size; and 2 mm for a 40 inch class screen size (for example, see Patent Documents 9 to 15).

On the other hand, when the reflector was formed only by a polycarbonate resin/titanium oxide-based thermoplastic resin composition having a light reflection function, it was difficult to suppress warping and deformation by thermal expansion due to a temperature rise. It was also difficult to secure rigidity for forming a chassis for the purpose of supporting the liquid crystal panel, as needed (for example, see Patent Documents 16 and 17). Although several methods have been suggested for increasing heat dissipation by improving the structure of the light source electrode terminal, i.e., a heat generation source, any of them fails to reduce the number of components (for example, see Patent Documents 18 to 20).
Patent Document 1: Japanese Patent Laid-Open Publication No. 2004-22352
Patent Document 2: Japanese Patent Laid-Open Publication No. 2004-127643
Patent Document 3: Japanese Patent Laid-Open Publication No. 2001-215497
Patent Document 4: Japanese Patent Laid-Open Publication No. 2001-13880
Patent Document 5: Japanese Patent Laid-Open Publication No. 2001-22285
Patent Document 6: Japanese Patent Laid-Open Publication No. 2003-346537
Patent Document 7: Japanese Patent Laid-Open Publication No. 2002-72204
Patent Document 8: Japanese Patent Laid-Open Publication No. 2002-7503
Patent Document 9: Japanese Patent Laid-Open Publication No. 2004-55182
Patent Document 10: Japanese Patent Laid-Open Publication No. 2004-139871
Patent Document 11: Japanese Patent Laid-Open Publication No. 2004-39533
Patent Document 12: Japanese Patent Laid-Open Publication No. 2004-47151
Patent Document 13: Japanese Patent Laid-Open Publication No. 2004-55524
Patent Document 14 Japanese Patent Laid-Open Publication No. 2004-29738
Patent Document 15: Japanese Patent Laid-Open Publication No. 2004-063459
Patent Document 16: Japanese Patent Laid-Open Publication No. 2004-102119
Patent Document 17: Japanese Patent Laid-Open Publication No. 2003-162901
Patent Document 18: Japanese Patent Laid-Open Publication No. 2004-134281
Patent Document 19: Japanese Patent Laid-Open Publication No. 2001-216807
Patent Document 20: Japanese Patent Laid-Open Publication No. 2003-234012

### DISCLOSURE OF THE INVENTION

### [Problems to be Solved by the Invention]

The present invention was undertaken to solve the above problem, and an object thereof is to enable reduction of the number of components in the lighting unit and reduction of the number of assembly steps, and to provide a multilayered sheet for light reflection for forming a thin and lightweight reflector, a reflector using it, a lighting unit equipped with the reflector, and a liquid crystal display device equipped with the lighting unit.

### [Means for Solving the Problems]

The present inventors devoted themselves to the study for solving the above problem. As a result, they found that the problem was solved by using a multilayered sheet for light reflection comprising a light reflecting resin layer (A) and a resin substrate layer (B) which contained an inorganic filler in an amount of 30% by mass or more and had the flexural modulus of 5 GPa or more, and further by using a multilayered sheet for light reflection with a flexible resin layer (C) laminated on the side of the resin substrate layer (B). The present invention was accomplished on the basis of this knowledge.

That is, the present invention comprises
(1) a multilayered sheet for light reflection comprising a light reflecting resin layer (A) and a resin substrate layer (B) which contains an inorganic filler in an amount of 30% by mass or more and has the flexural modulus of 5 GPa or more,
(2) the multilayered sheet for light reflection according to (1), wherein the Y-value of reflected light of the light reflecting resin layer (A) is 95 or greater,
(3) the multilayered sheet for light reflection according to (1) or (2), wherein the thermal conductivity of the resin substrate layer (B) is 1 W/m·° C. or higher,
(4) the multilayered sheet for light reflection according to any of (1) to (3), wherein the flexible resin layer (C) is formed to be (A)/(B)/(C),
(5) the multilayered sheet for light reflection according to (4), wherein the tensile elongation of the flexible resin layer (C) is 30% or more,
(6) the multilayered sheet for light reflection according to any of (1) to (5), wherein the light reflecting resin layer (A) comprises a polycarbonate-based resin composition containing titanium oxide in an amount of 20 to 60% by mass, or a thermoplastic resin porous reflective film or sheet,
(7) the multilayered sheet for light reflection according to any of (1) to (6), wherein the inorganic filler contained in the resin substrate layer (B) is constituted by at least 2 kinds selected from talc, mica, wollastonite, kaolin, calcium carbonate, aluminum oxide, graphite, boron nitride, titanium oxide, glass fiber and carbon fiber,
(8) the multilayered sheet for light reflection according to any of (1) to (7), wherein the thickness of the light reflecting resin layer (A) is in a range from 0.1 to 2 mm, that of the resin substrate layer (B) is from 0.3 to 1 mm, and that of the flexible resin layer (C) is from 0.1 to 0.5 mm,
(9) a reflector comprising the multilayered sheet for light reflection according to any one of (1) to (8),
(10) the reflector according to (9), comprising a light reflecting plate, a boss portion for attaching a circuit, a reinforced rib portion and a light diffuser panel supporting frame, and, optionally comprising a lamp holder, a lamp supporter and a light diffuser panel supporting column integrated in a single piece,
(11) a method for producing the reflector according to (9) or (10), wherein the reflector is formed by a thermoforming method, compression molding method and/or folding processing method,
(12) a lighting unit equipped with the reflector according to (9) or (10), and
(13) a liquid crystal display device equipped with the lighting unit according to (12).

### [Effects of the Invention]

The present invention enables the reduction of the number of components in the lighting unit and the number of assembly steps, and provides a multilayered sheet for light reflection for forming a thin and lightweight reflector, a reflector using it, a lighting unit equipped with the reflector, and a liquid crystal display device equipped with the lighting unit.

### BRIEF DESCRIPTION OF THE DRAWINGS

FIG. 1 is a cross-sectional view presenting an example of a light guiding backlight, which uses the reflector composed of the multilayered sheet for light reflection of the present invention.

FIG. 2 is a cross-sectional view presenting an example of a linear light source direct-type backlight, which uses a reflector for the linear light source direct-type backlight having a corrugated plate-shaped reflector composed of the multilayered sheet for light reflection of the present invention.

FIG. 3 is a cross-sectional view presenting an example of a point light source direct-type backlight, which uses a reflector for the point light source direct-type backlight having a plurality of parabolic cross-sectional arrays on the bottom of a reflective surface composed of the multilayered sheet for light reflection of the present invention.

FIG. 4 is a diagram presenting an example of the reflector for the point light source direct-type backlight used in FIG. 3, which has a plurality of parabolic cross-sectional arrays on the bottom of the reflective surface comprising the multilayered sheet for light reflection of the present invention.

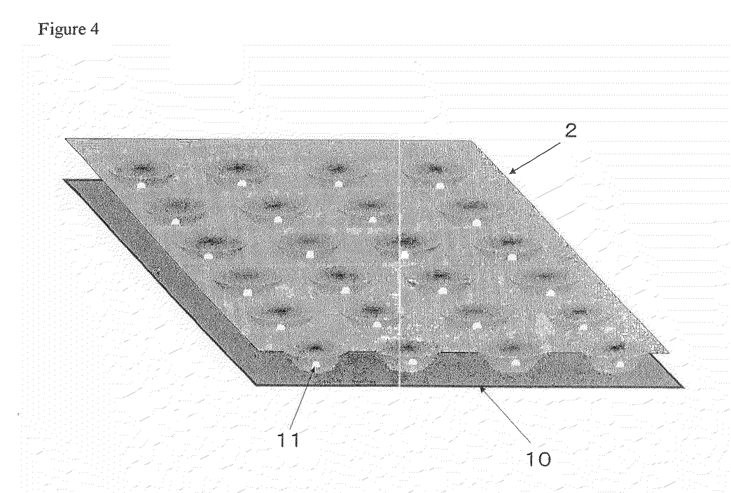

FIG. 5 is a cross-sectional view of the reflector for the point light source direct-type backlight presented in FIG. 4, which has a plurality of parabolic cross-sectional arrays on the bottom of the reflective surface.

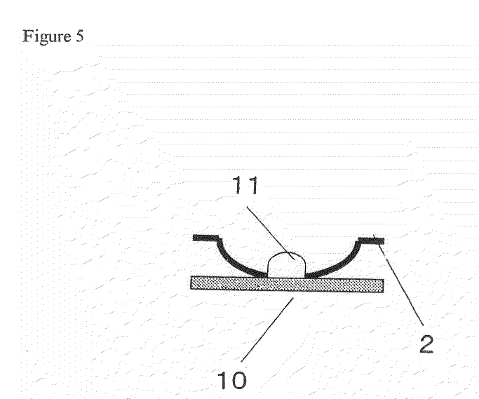

### EXPLANATION OF REFERENCE NUMERALS

1: light source (cold cathode fluorescent lamp, hot cathode fluorescent lamp, external electrode cathode fluorescent lamp and the like)

2: light reflecting plate composed of the multilayered sheet for light reflection of the present invention

3: optical films (light diffusing film, prism sheet and the like)

4: hinge portion

5: light guide plate

6: light diffusing film

7: prism sheet

8: light diffuser panel

9: front chassis

10: metal base for LED circuit

11: LED light source

### BEST MODE FOR CARRYING OUT THE INVENTION

Hereinafter, the present invention will be explained in detail.

The present invention relates to a multilayered sheet for light reflection used for production of a reflector which constitutes a lighting unit (backlight) for a liquid crystal display device, a reflector using it, a lighting unit equipped with the reflector, and a liquid crystal display device equipped with the lighting unit.

The multilayered sheet for light reflection of the present invention is characterized by that it comprises the light reflecting resin layer (A) and the resin substrate layer (B) which contains an inorganic filler in an amount of 30% by mass or more and has the flexural modulus of 5 GPa or more.

The multilayered sheet enhances the rigidity of the light reflecting plate and the reflector prepared by molding the multilayered sheet, suppresses twist of the reflector, a problem taking place in a backlight of a large screen, and enables thinning and weight saving.

As the light reflective resin layer (A), it is preferred to use (i) a porous oriented reflective sheet, (ii) a supercritical foamed reflective sheet, (iii) a multilayered sheet composed of several hundred of resin layers with a thickness of ¼λ and different refractive index, (iv) a reflective sheet composed of a titanium oxide-containing thermoplastic resin composition or the like.

(i) is exemplified by a white polyethylene terephthalate (PET) film such as E6SV and E60L manufactured by Toray Industries Inc., and a polypropylene (PP) porous oriented film such as White Refstar manufactured by Mitsui Chemicals, Inc., (ii) is exemplified by an ultrafinely foamed light reflecting plate MCPET (registered trademark) manufactured by Furukawa Electric Co., Ltd., which is prepared by foaming a polyester film with a supercritical gas so as to have an average pore size of 20 μm or less, (iii) is exemplified by ESR reflective sheet manufactured by Sumitomo 3M Limited, and (iv) is exemplified by a polycarbonate resin composition prepared by blending titanium oxide to a polycarbonate resin in an amount of 30 to 60% by mass. It is preferred that the thickness of the light reflective resin layer (A) is from 0.1 to 2 mm.

It is preferred that the Y-value of the reflected light of the light reflective resin layer (A) that constitutes the light reflective multilayered sheet of the present invention is 95 or more, more preferably 98 or more, and further more preferably 99 or more. It is preferred that the total light transmittance is 0.5% or less, more preferably 0.2% or less, and further more preferably 0.1% or less. There is no particular limitation on setting a greater Y-value. By setting the Y-value as large as possible, the brightness characteristic as a light reflector improves in practical application.

There is no particular limitation on the resin composition for light reflective resin layer used for the formation of the light reflective resin layer (A), but it is preferred to use a polycarbonate resin composition containing, for example, a polycarbonate resin or the polymer blend as a matrix resin component, blended with an organopolysiloxane in an amount of 0.1 to 5 parts by mass, and, if necessary, a flame retardant and flame retardant auxiliary in an amount of 0.1 to 5 parts by mass in total, based on 100 parts by mass of the polycarbonate resin composition containing titanium oxide in an amount of 8 to 50% by mass. The resin composition for the light reflective resin layer provides a light reflective resin sheet excelling in reflectance, light blocking effect and light resistance. When the content of titanium oxide is less than 8% by mass, the reflectance and light blocking effect are insufficient. In the case of exceeding 50% by mass, it becomes difficult to blend titanium oxide to the polycarbonate resin. When titanium oxide is blended in the polycarbonate resin, it is necessary to blend an organopolysiloxane in an amount of 0.1 to 5 parts by mass, in order to suppress decomposition of the polycarbonate resin by titanium oxide. With the organopolysiloxane of less than 0.1 parts by mass, decomposition may not be suppressed. With more than 5 parts by mass, excessive organopolysiloxane causes marked generation of mold deposit. Preferred examples of an organopolysiloxane include a silicone-based compound in which an alkoxy group such as methoxy and ethoxy group is introduced in a silicone-based compound (for example, organosiloxane) and the like.

As the flame retardant, a known one such as a phosphoric ester-based compound and an organopolysiloxane-based compound are used. As the flame retardant auxiliary, a Teflon (registered trademark) may be used as an anti-dripping agent. The total amount of the flame retardant and flame retardant auxiliary to be blended is from 0.1 to 5 parts by mass, based on 100 parts by mass of the polycarbonate resin composition containing titanium oxide in an amount of 8 to 50% by mass. In the case of less than 0.1 part by mass, the flame retardance is not exhibited, while in the case of more than 5 parts by mass, the glass transition temperature declines excessively due to the plasticizing effect, and the heat resistance is impaired. The preferred amount thereof is from 1 to 4 parts by mass.

The resin substrate layer (B) with the flexural modulus of 5 GPa or more has a function as a high rigidity layer or high rigidity and high thermal conductive layer. There is no particular limitation on the resin substrate layer (B), as long as it suppresses the twist of the resultant reflector, but it is preferred to use a resin substrate layer comprising a thermoplastic resin composition having moldability, heat resistance, flame retardance and high elastic modulus.

As the thermoplastic resin composition, it is preferred to use a resin composition comprising a thermoplastic resin with thermal deformation temperature of 120° C. or higher, such as a polycarbonate-based resin, PBT-based resin, PET-based resin and polyether sulfone-based resin, or a polymer blend thereof containing 2 or more kinds as a matrix resin, wherein the thermoplastic resin contains a powdered inorganic filler or reinforced fiber in an amount of 5 parts by mass or more, based on 100 parts by mass of the thermoplastic resin, and a flame retardant, optionally.

The preferred thickness of the resin substrate layer (B) is about 0.3 to 1 mm, although it varies depending on the flexural modulus of the layer to be constituted.

In the light reflective multilayered sheet of the present invention, the flexural modulus of the resin substrate layer (B) (a high-rigidity resin layer) is 5 GPa or more. With the flexural modulus of 5 GPa or more, the deflection of the reflector formed from the light reflective multilayered sheet is suppressed. The preferred flexural modulus is preferably 7 GPa or more, more preferably 10 GPa or more, and further more preferably 15 GPa or more. Higher elastic modulus enables forming of a thinner resin substrate layer (B), and provides a multilayered sheet excelling in light weight and moldability. On the other hand, in order to enhance the flexural modulus, it is necessary to blend a large amount of an inorganic filler, such as a powdered inorganic filler and reinforced fiber, into the thermoplastic resin to be used. This invites decline in extrusion moldability when forming the resin substrate layer (B) by extrusion molding. It is important to balance between the flexural modulus and extrusion moldability, and to select the amount of the inorganic filler to be blended and the thermoplastic resin used as the matrix resin in a proper manner according to the viscoelasticity. In view of the extrusion moldability, it is preferred to use the powdered inorganic filler and thus enhance the flexural modulus. When the reinforced fiber is used concomitantly, it is preferred to restrict the amount of the fiber up to 10% by mass of the composition, since the reinforced fiber such as glass fiber and carbon fiber causes decline in the extrusion moldability. It is preferred that the total amount of them is about 80 to 40 vol % of a volume of the resin matrix. It is preferred that the amount of the powdered inorganic filler to be blended is from 20 to 60% by mass, although it varies depending on the specific gravity of the composition. In the case of less than 20% by mass, sufficient flexural modulus is not obtained and therefore the reflector is likely to be deflected, while with more than 60% by mass, the extrusion moldability extremely declines and the sheet forming becomes difficult. For example, it is possible to secure the flexural modulus of 10 GPa or more in the polycarbonate resin composition by blending 40% by mass of talc and 20% by mass of mica as the powdered inorganic filler. It is also possible to enhance the thermal conductivity of the resin substrate layer (B) collaterally, by selecting combination of the powdered inorganic filler and reinforced fiber, and the amount of them to be blended.

When the polycarbonate resin is used as a matrix resin component, as the thermoplastic resin to achieve high rigidity of the resin substrate layer (B), it is preferred to use a polycarbonate resin composition containing an organopolysiloxane in an amount of 0.1 to 5 parts by mass, and, if necessary, a flame retardant and flame retardant auxiliary in an amount of 0.1 to 5 parts by mass as the total amount, based on 100 parts by mass of the polycarbonate resin composition containing 2 or more kinds of inorganic fillers in an amount of 20 to 60% by mass. The inorganic filler stated herein denotes inorganic fillers such as talc, mica, wollastonite, kaolin and calcium carbonate, and reinforced fibers such as glass fiber and carbon fiber. The present inorganic filler is characterized by containing 2 or more kinds thereof.

It is preferred that the thermal conductivity of the resin substrate layer (B) of the present invention is 1 W/m·° C. or higher. The higher the thermal conductivity is, the more excellent the heat dissipation is against the heat from the light source, so that the decline in luminous efficiency of the light source is suppressed. More preferred thermal conductivity is 5 to 15 W/m·° C. Generally speaking, in order to secure the thermal conductivity of 15 W/m·° C. or more, it may be necessary to adjust the amount of the powdered inorganic filler and reinforced fiber to be blended to a high concentration. This not only deteriorates the extrusion moldability, but also aggravates wettability between the resin and the substances to be blended, generating dust emission, which may cause a foreign substance defect when it is applied to a backlight for a liquid crystal display. In light of the occurrence of these defects, it is necessary to select the combination and amount of the powdered inorganic filler and reinforced fiber to be used in a proper manner.

It is preferred that the thickness of the light reflective multilayered sheet of the present invention, which is composed of the light reflective resin layer (A) and the resin substrate layer (B), is from 0.5 to 3 mm. When the thickness is less than 0.5 mm, the rigidity of the reflector is insufficient even though the reflector contains the resin substrate layer (B), and the light blocking effect is unlikely to be maintained. While in the case of exceeding 3 mm, the rigidity and optical properties (reflection and light blocking) are high enough, but a drawback of weight increase occurs.

It is preferred that the light reflective multilayered sheet of the present invention forms the flexible resin layer (C) with a tensile elongation of 30% or more, on the side of the resin substrate layer (B), so as to be (A)/(B)/(C). By providing the flexible resin layer (C) with a tensile elongation of 30% or more, it is possible to impart folding processability and hinge characteristics. Further, it provides a reinforcement effect to the portion where stress is likely to be concentrated, such as a corner and rib portion of the reflector. Preferred tensile elongation is preferably 50% or more, and more preferably 100% or more.

By forming a three-layered structure composed of at least the light reflective resin layer (A), resin substrate layer (B) and flexible resin layer (C), it is possible to improve strength, which is required to the light reflective multilayered sheet. In other words, the flexible resin layer (C) suppresses fragility originated from the resin substrate layer (B) at the edge, rib and folded portions of the reflector when molding the reflector, and thus extends the latitude in moldability and mold shape. There is no particular limitation on the flexible resin layer (C), as long as the resin exhibits ductility at room temperature, at which the flexibility is measured, but it is preferred to use the polycarbonate resin composition containing additives such as an inorganic filler or a dye or pigment, and a flame retardant, if necessary, in an amount of less than 5 parts by mass, in view of flame retardance, heat resistance and ductility. For example, a resin composition comprising a polycarbonate resin added with carbon black in an amount of less than 5 parts by mass provides not only flexibility, but also light blocking effect simultaneously.

The preferred thickness of the respective layers in the multilayered sheet with the three-layered structure comprising the light reflective resin layer (A), resin substrate layer (B) and flexible resin layer (C) is from 0.1 to 2 mm for the light reflective resin layer (A), from 0.3 to 1 mm for the resin substrate layer (B), and from 0.1 to 0.5 mm for the flexible resin layer (C).

The reflector of the present invention is characterized by being formed using the multilayered sheet for light reflection according to any one of (1) to (8) mentioned above. By adapting the present layer constitution to the multilayered sheet to be used upon forming the reflector, it is possible to provide a lightweight and large-sized reflector with high brightness and suppressed deflection.

The reflector of the present invention preferably comprises a light reflecting plate, a boss portion for attaching a circuit, a reinforced rib portion and a light diffuser panel supporting frame, and, optionally comprises a lamp holder, a lamp supporter and a light diffuser panel supporting column integrated in a single piece.

The reflector can be formed by a common thermoforming method (vacuum forming method), compression molding method and/or folding processing method by using a multilayered sheet for light reflection.

The present invention also provides a lighting unit, which is equipped with a light guide plate mounted with the reflector comprising a light reflecting plate, a boss portion for attaching a circuit, a reinforced rib portion and a light diffuser panel supporting frame, and, optionally comprising a lamp holder, a lamp supporter and a light diffuser panel supporting column integrated in a single piece, and a light source. For example, a light source is disposed on a thick wall portion of the light guide plate, so as to constitute the lighting unit composed of an edge-type surface light source such as a liquid crystal television, personal computer and display. When the lighting unit of the present invention is employed on the liquid crystal display device, either of a backlight method or a front light method can be employed.

A plural number of light sources are used, according to a display screen size of the liquid crystal display device and brightness required to the lighting unit. The light sources to be used include a linear or U-shaped cold cathode fluorescent lamp (CCFL), a point light source such as an optical semiconductor element (LED), and those disposing them linearly or in plane. The light source support generally used is not made of sheet metal, but an injection molding product of the thermoplastic resin composition. Among others, the polycarbonate resin composition containing titanium oxide has a light reflection function, and a structure to be employed is that forming a rib structure outside the light source supporting function, so as to enhance torsional rigidity of the light reflecting plate.

The light diffuser panel is generally formed by acrylic resins such as polyacrylic acid, poly(methyl methacrylate) (PMMA), polyacrylonitrile, ethyl acrylate-2-chloroethyl acrylate copolymer, n-butyl acrylate-acrylonitrile copolymer, acrylonitrile-styrene copolymer, acrylonitrile-butadiene copolymer and acrylonitrile-butadiene-styrene copolymer; a polycarbonate resin; or, in recent years, a resin composition formed by blending a light diffusing agent to a transparent resin such as a cyclic olefin resin and having the thickness of about 1 to 3 mm. It is selected according to a liquid crystal display screen size and lighting unit.

Regarding optical films, those with a plurality of functions are laminated. Generally, the optical films include a light diffusing film for equalizing the surface brightness of the lighting unit and a prism sheet having a brightness enhancing function. These films are used by laminating plural films, in accordance with the brightness and uniformity of the brightness. The light guide plate is generally formed by acrylic resins such as polyacrylic acid, poly(methyl methacrylate) (PMMA), polyacrylonitrile, ethyl acrylate-2-chloroethyl acrylate copolymer, n-butyl acrylate-acrylonitrile copolymer, acrylonitrile-styrene copolymer, acrylonitrile-butadiene copolymer and acrylonitrile-butadiene-styrene copolymer; a polycarbonate resin; or, in recent years, a transparent resin having a high light guiding property, such as a cyclic olefin resin. It is selected in accordance with the environment of use, screen size and so on. On the backside of the light guide plate, scattering patterns are printed with white ink having light-diffusing properties, and fine irregularity is processed. The scattering patterns and fine irregularity are optical transducers, intending to allow the incident light from a light source or point light source to surface-emit uniformly and efficiently in the exit direction.

### EXAMPLES

Hereinafter, the present invention will be explained in further detail by way of Examples, but the present invention is in no way limited by the Examples.

The physical properties were measured in accordance with the following methods.

### (1) Flexural Modulus (GPa)

Measured in accordance with JIS K7171.

### (2) Y-Value of Reflected Light

A spectral reflection coefficient was measured using a standard white board authorized by N.P.L (UK's National Physical Laboratory), under D65 light source at 10° viewing angle using a color and color difference meter LCM2020 Plus manufactured by Macbeth Corp., and the Y-value was calculated from the measured results.

### (3) Total Light Transmittance (%)

Measured in accordance with JIS K7105.

### (4) Tensile Elongation (%)

Measured in accordance with JIS K7127.

### (5) Thermal Conductivity (W/m·° C.)

Measured by a hot disk method, using a thermophysical property analyzer TPA-501 manufactured by Kyoto Electronics Manufacturing Co., Ltd.

### (6) Brightness (%)

As is described in Example, a 32 inch backlight using the reflector was prepared. Then, brightness was measured using a color heterogeneity analyzer, Eyescale 3 manufactured by Eye Scale Corporation.

### (7) Deflection (mm)

A rectangular thermoforming product was placed on a plane surface, and two diagonal corners were lifted. The height to be lifted while the remaining two diagonal corners were touching on the plane surface was determined as deflection.

### (1) Production of Resin Compositions Constituting the Respective Layers

### Production Example 1

### Production of Resin Composition for Light Reflective Resin Layer (A-1)

1.8 parts by mass of an organopolysiloxane (trade name BY16-161; manufactured by Dow Corning Toray Co., Ltd.), 0.3 part by mass of polytetrafluoroethylene (PTFE, trade name CD076; manufactured by Asahi Glass Co., Ltd.) and 0.1 part by mass of triphenylphosphine (trade name JC263; manufactured by Johoku chemical Co., Ltd.) were mixed in total 100 parts by mass of matrix composed of 32 parts by mass of a polycarbonate-based resin composed of a copolymer of polycarbonate and polydimethylsiloxane (Taflon FC1700 manufactured by Idemitsu Kosan Co., Ltd.; Mv=17,000, PDMS content=3.0% by mass), 18 parts by mass of a bisphenol A-type straight chain polycarbonate (Taflon FN2500A manufactured by Idemitsu Kosan Co., Ltd.; Mv=25,000) and 50 parts by mass of powdered titanium oxide (trade name PF726; manufactured by Ishihara Sangyo Kaisha Ltd.). The resultant mixture was molten and kneaded at 280° C. with a twin screw extruder to form it into a pellet form, so as to obtain a resin composition for the light reflective resin layer (A-1).

### Production Example 2

### Production of Resin Composition for Resin Substrate Layer (B-1)

1 part by mass of an organopolysiloxane (trade name BY16-161; manufactured by Dow Corning Toray Co., Ltd.), 0.05 part by mass of an antioxidant (triphenylphosphine (trade name JC263; manufactured by Johoku chemical Co., Ltd.)) and 0.3 part by mass of Teflon (registered trademark) powder (polytetrafluoroethylene (PTFE, trade name CD076; manufactured by Asahi Glass Co., Ltd.)) were blended in total 100 parts by mass of matrix composed of 40 parts by mass of the polycarbonate-based resin composed of the copolymer of polycarbonate and polydimethylsiloxane (FC1700 manufactured by Idemitsu Kosan Co., Ltd.), 40 parts by mass of talc and 20 parts by mass of mica. The resultant mixture was then kneaded at 280° C. with a twin screw extruder to form it into a pellet form, so as to obtain a resin composition for the resin substrate layer (B-1).

### Production Example 3

### Production of Resin Composition for Resin Substrate Layer (B-2)

1 part by mass of an organopolysiloxane (trade name BY16-161; manufactured by Dow Corning Toray Co., Ltd.), 0.05 part by mass of an antioxidant (triphenylphosphine (trade name JC263; manufactured by Johoku chemical Co., Ltd.)) and 0.3 part by mass of Teflon (registered trademark) powder (polytetrafluoroethylene (PTFE, trade name CD076; manufactured by Asahi Glass Co., Ltd.)) were blended in total 100 parts by mass of matrix composed of 40 parts by mass of the polycarbonate-based resin composed of the copolymer of polycarbonate and polydimethylsiloxane (FC1700 manufactured by Idemitsu Kosan Co., Ltd.), 40 parts by mass of talc and 20 parts by mass of graphite. The resultant mixture was then kneaded at 280° C. with a twin screw extruder to form it into a pellet form, so as to obtain a resin composition for the resin substrate layer (B-2).

### Production Example 4

### Production of Resin Composition for Flexible Resin Layer (C-1)

0.3 part by mass of an organic alkali metal salt (Megafac F114 manufactured by Dainippon Ink and Chemicals Inc.), 0.3 part by mass of a Teflon (registered trademark) powder reactive silicone compound (KR511 manufactured by Shin-Etsu Chemical Co., Ltd.), 1 part by mass of black color master batch and 0.03 part by mass of an antioxidant were blended in 100 parts by mass of the polycarbonate-based resin composed of the copolymer of polycarbonate and polydimethylsiloxane (FC1700 manufactured by Idemitsu Kosan Co., Ltd.). The resultant mixture was then kneaded at 280° C. with a twin screw extruder to form it into a pellet form, so as to obtain a resin composition for the flexible resin layer (C-1).

### Example 1-1

### Production of a Multilayered Sheet

Using the resin composition for the resin substrate layer (B-1) and the resin composition for the flexible resin layer (C-1), two-kind/two-layered multilayered extrusion molding was carried out at extrusion temperature of 260° C. E6SV manufactured by Toray Industries Inc. was used as the light reflective resin layer (A). E6SV was inserted in a roll immediately after the multilayered extrusion molding (roll temperature of 100° C.) to form a laminate, so as to obtain a multilayered sheet for light reflection having a three-kind/three-layered structure.

The Y-value of reflected light was 99.5 for the light reflective resin layer (A), i.e., at the single layer of E6SV.

The thickness of the resin substrate layer was 0.5 mm, and the flexural modulus of the single layer was 10 GPa.

The thickness of the flexible resin layer was 0.1 mm, and the tensile elongation of the single layer was 101%.

The layer configuration was: light reflective resin layer/resin substrate layer/flexible resin layer=0.4/0.5/0.1 mm, which was referred to as a three-layered multilayered sheet for light reflection (1-1) with a total thickness of 1 mm.

### Example 2-1

Using the resin composition for the light reflective resin layer (A-1) and the resin composition for the resin substrate layer (B-1), extrusion molding was carried out under the same extrusion conditions as in Example 1-1, so as to obtain a two-kind/two-layered multilayered sheet for light reflection. The Y-value of reflected light of the resultant multilayered sheet for light reflection was 98.5 as a single layer. The thickness of the resultant light reflective resin layer was 0.4 mm, the thickness of the resin substrate layer was 0.5 mm, and the flexural modulus of the single layer was 10 GPa.

The layer configuration was: light reflective resin layer/resin substrate layer=0.4/0.5 mm, which was referred to as a two-layered multilayered sheet for light reflection (2-1) with a total thickness of 0.9 mm.

### Example 3-1

Using the resin composition (A-1) for the light reflective resin layer, the resin composition (B-1) for the resin substrate layer, and the resin composition (C-1) for the flexible resin layer, extrusion molding was carried out under the same extrusion conditions as in Example 1-1, so as to obtain a three-kind/three-layered multilayered sheet for light reflection. The Y-value of reflected light was 98.5 at a single light reflective resin layer of the resultant multilayered sheet.

The thickness of the resultant light reflective resin layer was 0.4 mm, the thickness of the resin substrate layer was 0.5 mm, and the flexural modulus of the single layer was 10 GPa.

The thickness of the flexible resin layer was 0.1 mm, and the tensile elongation of the single layer was 101%.

The layer configuration was: light reflective resin layer/resin substrate layer/flexible resin layer=0.4/0.5/0.1 mm, which was referred to as a three-layered multilayered sheet for light reflection (3-1) with a total thickness of 1.0 mm.

### Example 4-1

Using the resin composition for the light reflective resin layer (A-1), the resin composition for the resin substrate layer (B-2) and the resin composition for the flexible resin layer (C-1), extrusion molding was carried out under the same extrusion conditions as in Example 1-1, so as to obtain a three-kind/three-layered multilayered sheet for light reflection (3-1). The Y-value of reflected light was 98.5 at a single light reflective resin layer of the resultant multilayered sheet for light reflection.

The thickness of the resultant light reflective resin layer was 0.4 mm as a single layer, the thickness of the resin substrate layer was 0.5 mm, the thermal conductivity of the single layer was 3 W/° C., and the flexural modulus was 9.5 GPa.

The thickness of the flexible resin layer was 0.1 mm, and the tensile elongation of the single layer was 101%.

The layer configuration was: light reflective resin layer/resin substrate layer/flexible resin layer=0.4/0.5/0.1 mm, which was referred to as a three-layered multilayered sheet for light reflection (4-1) with a total thickness of 1.0 mm.

### Comparative Example 1-1

Using the resin composition for light reflective resin layer (A-1), extrusion molding was carried out at extrusion temperature of 260° C., so as to obtain a light reflective sheet as a single layer with a thickness of 1.0 mm. The Y-value of reflected light of the resultant light reflective sheet was 98.5.

### Example 1-2

### Production of a Reflector for Light Guiding Backlight

Using the three-layered multilayered sheet for light reflection (1-1) prepared in Example 1-1, a reflector (lamp housing) was thermoformed at 180° C. for installation of a light guide plate, a light entrance window for allowing a light source to be contact-disposed on the light guide plate and a reflector covering the light source were built by means of punching (trimming), and further, a folding allowance was provided for forming a frame around an opening portion of the reflector, so as to form a frame on a light exit face of the light guide plate by folding process. Thus a 17 inch reflector was molded.

### Example 2-2

### Production of a Reflector for Direct-Type Backlight for a Linear Light Source

Using the two-layered multilayered sheet for light reflection (2-1) prepared in Example 2-1, vacuum forming was carried out at 180° C., so as to form a 32 inch reflector integrating a light reflecting plate having a corrugated reflective surface, a lamp holder, a diffuser panel supporting column, a diffuser panel supporting frame, a reinforced rib structure at the periphery of the reflector, and a boss portion for clamping screws on a reverse side of the bottom of the reflecting plate.

### Example 3-2

### Production of a Reflector for Direct-Type Backlight for a Linear Light Source

Using the three-layered multilayered sheet for light reflection (3-1) prepared in Example 3-1, vacuum forming was carried out at 180° C., so as to form a 32 inch reflector integrating a light reflecting plate having a corrugated reflective surface, a lamp holder, a diffuser panel supporting column, a diffuser panel supporting frame, a reinforced rib structure at the periphery of the reflector, and a boss portion for clamping screws on a reverse side of the bottom of the reflecting palate. The deflection of the reflector was 30 mm.

### Example 4-2

### Production of a Reflector for Direct-Type Backlight for a Linear Light Source

Using the three-layered multilayered sheet for light reflection (4-1) prepared in Example 4-1, vacuum forming was carried out at 180° C., so as to form a 32 inch reflector integrating a light reflecting plate having a corrugated reflective surface, a lamp holder, a diffuser panel supporting column, a diffuser panel supporting frame, a reinforced rib structure at the periphery of the reflector, and a boss portion for clamping screws on a reverse side of the bottom of the reflecting plate. The deflection of the reflector was 30 mm.

Example 5-2

### Production of a Reflector for Direct-Type Backlight for a Point Light Source

Using the three-layered multilayered sheet for light reflection (4-1) prepared in Example 4-1, compression molding was carried out to form a reflector having a plurality of parabolic cross-sectional arrays on a reverse side of the bottom of the reflecting plate. Through holes for LED light source exposure were formed on the bottom of a minimum portion of the parabola.

### Comparative Example 1-2

### Production of a Reflector for Direct-Type Backlight for a Linear Light Source

Using the single-layered sheet for light reflection prepared in Comparative Example 1-1, vacuum forming was carried out at 180° C., so as to form a 32 inch reflector integrating a light reflecting plate having a corrugated reflective surface, a lamp holder, a diffuser panel supporting column, a diffuser panel supporting frame, a reinforced rib structure at the periphery of the reflector, and a boss portion for clamping screws on a reverse side of the bottom of the reflector. The deflection of the reflector was 80 mm.

### Example 1-3

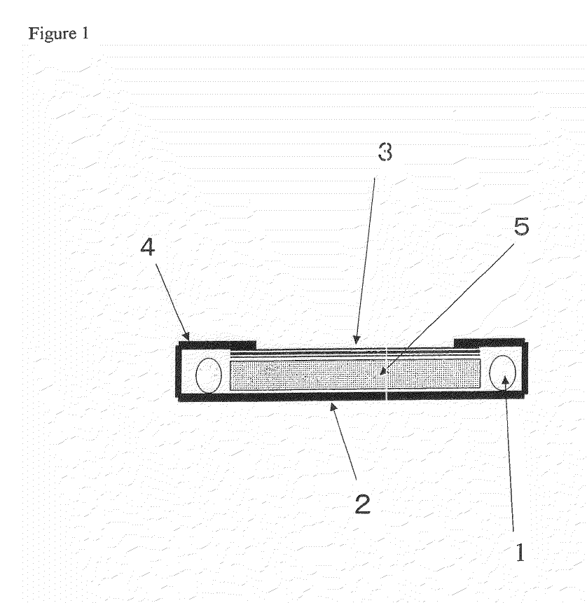

### Production of a Light Guiding Backlight shown in FIG. 1

FIG. 1 shows a cross-sectional view of the light guiding backlight prepared in the present Example.

After disposing a light guide plate 5 on the reflector prepared in Example 1-2, the folding allowance (frame portion) built around the opening portion of the reflector was folded to cover the light guide plate, and then the light guide plate 5 and the reflector were jointed and fixed by ultrasonic welding. The light sources 1 (cold cathode fluorescent lamps) were inserted through the opening portion built at the side end of the reflector containing the resultant light guide plate 5, the light sources were fixated with an electrode terminal cover made of silicone rubber and connected with an inverter, so as to complete the backlight shown in FIG. 1. When the brightness of the resultant backlight was measured, it showed brightness higher than that of a backlight in a conventional system composed of an E6SV reflective sheet and a sheet metal case by approx. 10%.

### Example 2-3

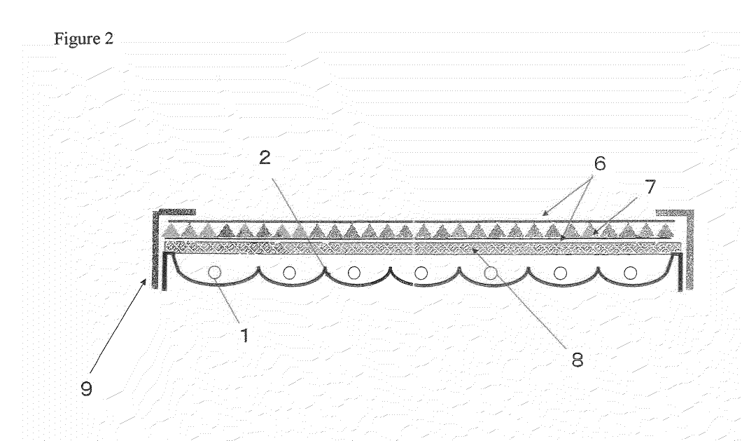

### Production of a Direct-Type Backlight shown in FIG. 2

FIG. 2 shows a cross-sectional view of the linear light source direct-type backlight prepared in the present Example.

A backlight shown in FIG. 2 was produced as follows: The light sources 1 (16 cold cathode fluorescent lamps, the total power consumption of 140 W) and an inverter were mounted on the reflector prepared in Example 2-2, the latter was connected with the light sources 1, the light diffuser panel 8 was mounted on the opening portion of the reflector, and the light diffusing film 6 was mounted on the light diffuser panel 8, so as to prepare the backlight composed of a 32 inch reflector without using a metal chassis by sheet metal working. When the brightness of the resultant backlight was measured, it showed brightness higher than that of backlights in conventional systems composed of the E6SV reflective sheet manufactured by Toray Industries Inc. and a sheet metal chassis by approx. 6% in all cases. When the temperature was measured by inserting a thermocouple in the backlight after lighting it for an hour, the inner atmospheric temperature was 80° C.

### Example 3-3

### Production of Direct-Type Backlight shown in FIG. 2

A backlight shown in FIG. 2 was produced as follows: The light sources 1 (16 cold cathode fluorescent lamps, the total power consumption of 140 W) and an inverter were mounted on the reflector prepared in Example 3-2, the latter was connected with the light sources 1, the light diffuser panel 8 was mounted on the opening portion of the reflector, and the light diffusing film 6 was mounted on the light diffuser panel 8, so as to prepare the backlight composed of a 32 inch reflector without using a metal chassis by sheet metal working. When the brightness of the resultant backlight was measured, it showed brightness higher than that of backlights in conventional systems composed of the E6SV reflective sheet manufactured by Toray Industries Inc. and a sheet metal chassis by approx. 6% in all cases. When the temperature was measured by inserting a thermocouple in the backlight after lighting it for an hour, the inner atmospheric temperature was 80° C.

### Example 4-3

### Production of Direct-Type Backlight shown in FIG. 2

A backlight shown in FIG. 2 was produced as follows: The light sources 1 (16 cold cathode fluorescent lamps, the total power consumption of 140 W) and an inverter were mounted on the reflector prepared in Example 4-2, the latter was connected with the light sources, the light diffuser panel 8 on the opening portion of the reflector, and the light diffusing film was mounted 6 on the light diffuser panel 8, so as to prepare the backlight composed of a 32 inch reflector without using a metal chassis by sheet metal working. When the brightness of the resultant backlight was measured, it showed brightness higher than that of backlights in conventional systems composed of the E6SV reflective sheet manufactured by Toray Industries Inc. and a sheet metal chassis by approx. 6% in all cases. When the temperature was measured by inserting a thermocouple in the backlight after lighting it for an hour, the inner atmospheric temperature was 70° C.

### Example 5-3

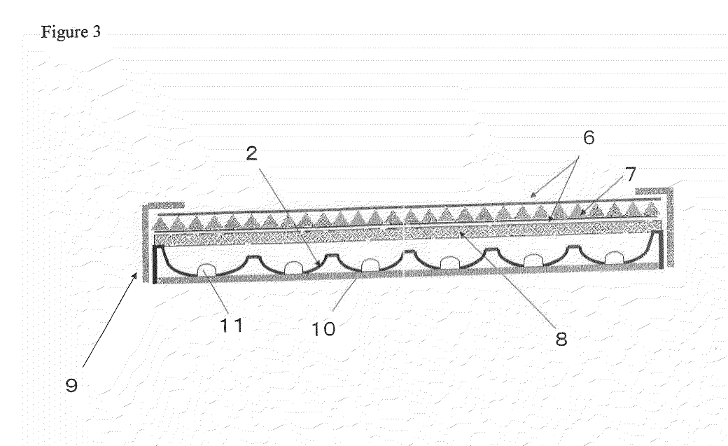

### Production of a Direct-Type Backlight shown in FIG. 3

FIG. 3 is a cross-sectional view of the point light source direct-type backlight prepared in the present Example.

A backlight shown in FIG. 3 was produced as follows: The point light sources 11 (210 LED light sources, the total power consumption of 200 W) and a control circuit on the reflector prepared in Example 5-2, the latter was connected with the light sources 1, the light diffuser panel 8 was mounted on the opening portion of the reflector, and the light diffusing film 6 was mounted on the light diffuser panel 8, so as to prepare the backlight composed of a 32 inch reflector without using a metal chassis by sheet metal working. When the brightness of the resultant backlight was measured, it showed brightness higher than that of backlights in conventional systems composed of the E60L reflective sheet manufactured by Toray Industries Inc. and a sheet metal laminate (Alset manufactured by Mitsubishi Plastics Inc.) by approx. 10% in any cases.

### Comparative Example 1-3

### Production of a Direct-Type Backlight

A backlight composed of a 32 inch reflector without using a metal chassis by sheet metal working was prepared by mounting light sources (16 cold cathode fluorescent lamps, the total power consumption of 140 W) and an inverter on the reflector prepared in Comparative Example 1-2, connecting with the light sources, mounting the diffuser panel on the opening portion of the reflector, and further the diffusing film on the diffuser panel.

### INDUSTRIAL APPLICABILITY

The present invention enables the reduction of the number of components in the lighting unit and reduction of the number of the assembly steps, and provides a multilayered sheet for light reflection for forming a thin and lightweight reflector, a reflector using it, a lighting unit equipped with the reflector, and a liquid crystal display device equipped with the lighting unit.

1. A multilayered sheet for light reflection, comprising a light reflecting resin layer (A) and a resin substrate layer (B) which contains an inorganic filler in an amount of 30% by mass or more and has the flexural modulus of 5 GPa or more.

2. The multilayered sheet for light reflection according to claim 1, wherein the Y-value of reflected light of the light reflecting resin layer (A) is 95 or greater.

3. The multilayered sheet for light reflection according to claim 1, wherein the thermal conductivity of the resin substrate layer (B) is 1 W/m·° C. or higher.

4. The multilayered sheet for light reflection according to claim 1, wherein the flexible resin layer (C) is formed to be (A)/(B)/(C).

5. The multilayered sheet for light reflection according to claim 4, wherein the tensile elongation of the flexible resin layer (C) is 30% or more.

6. The multilayered sheet for light reflection according to claim 1, wherein the light reflecting resin layer (A) comprises a polycarbonate-based resin composition containing titanium oxide in an amount of 20 to 60% by mass, or a thermoplastic resin porous reflective film or sheet.

7. The multilayered sheet for light reflection according to claim 4, wherein the light reflecting resin layer (A) comprises a polycarbonate-based resin composition containing titanium oxide in an amount of 20 to 60% by mass, or a thermoplastic resin porous reflective film or sheet.

8. The multilayered sheet for light reflection according to claim 1, wherein the inorganic filler contained in the resin substrate layer (B) is constituted by at least 2 kinds selected from talc, mica, wollastonite, kaolin, calcium carbonate, aluminum oxide, graphite, boron nitride, titanium oxide, glass fiber and carbon fiber.

9. The multilayered sheet for light reflection according to claim 4, wherein the thickness of the light reflecting resin layer (A) is in a range from 0.1 to 2 mm, that of the resin substrate layer (B) is from 0.3 to 1 mm, and that of the flexible resin layer (C) is from 0.1 to 0.5 mm.

10. A reflector comprising the multilayered sheet for light reflection according to any of claims 1 to 9.

11. The reflector according to claim 10, comprising a light reflecting plate, a boss portion for attaching a circuit, a reinforced rib portion and a light diffuser panel supporting frame, and, optionally comprising a lamp holder, a lamp supporter and a light diffuser panel supporting column integrated in a single piece.

12. A method for producing the reflector according to claim 10, the reflector being formed by a thermoforming method, compression molding method and/or folding processing method.

13. A method for producing the reflector according to claim 11, the reflector being formed by a thermoforming method, compression molding method and/or folding processing method.

14. A lighting unit equipped with the reflector according to claim 10.

15. A lighting unit equipped with the reflector according to claim 11.

16. A liquid crystal display device equipped with the lighting unit according to claim 14.

17. A liquid crystal display device equipped with the lighting unit according to claim 15.
